(19) United States
(12) Patent Application Publication
(10) Pub. No.: US 2021/0381115 A1
(43) Pub. Date: Dec. 9, 2021

(54) PRODUCTION OF LITHIUM VIA ELECTRODEPOSITION

(71) Applicant: UCHICAGO ARGONNE, LLC, Chicago, IL (US)

(72) Inventors: Donghyeon Kang, Willowbrook, IL (US); Edward F. Barry, Chicago, IL (US); John N. Hryn, Hawthorn Woods, IL (US)

(73) Assignee: UCHICAGO ARGONNE, LLC, Chicago, IL (US)

(21) Appl. No.: 16/894,210

(22) Filed: Jun. 5, 2020

(51) Int. Cl. C25B 1/14; C25D 3/02

(52) U.S. Cl. CPC C25B 1/14; C25D 3/02

(57) ABSTRACT

Methods and systems for scalable production of lithium metal through electrodeposition.

### GOVERNMENT SUPPORT CLAUSE

This invention was made with government support under Contract No. DE-AC02-06CH11357 awarded by the United States Department of Energy to UChicago Argonne, LLC, operator of Argonne National Laboratory. The government has certain rights in the invention.

### TECHNICAL FIELD

The present disclosure relates generally to methods for production of lithium. More specifically, the present disclosure describes methods and compositions of lithium produced by electrodeposition as a thin film.

### BACKGROUND

Lithium metal is an attractive material for use as an anode in batteries due to being the lightest and most electropositive metal with a theoretical specific coulometric capacity of 3860 mAh/g, density of 0.59 g/cm³, and negative reduction potential of −3.040 V vs. standard hydrogen electrode (“SHE”). Lithium is expected to play an increasingly large role in the energy needs as more consumer demand shifts from petroleum products to electricity. Common Li-ion batteries used for energy storage have a graphite anode and a lithium containing cathode, typically LiCoO₂.

However, use of lithium metal as an anode in rechargeable batteries has been plagued by several issues that cause its use to be extremely limited. A limited life cycle is one of the most critical issues with the technology both in terms of cost and feasibility. Most of the issues relate to the formation of dendrites during cycling. During the first few cycles of a cell's life, a solid-electrolyte interphase (“SEI”) is generated at the surface of the anode. The SEI consumes some of the available lithium in its makeup. When dendrites are formed during continued cycling, more and more lithium is consumed in the generation of SEI on the surface of the dendrites, resulting in continued capacity fade. In addition, dendrites can grow long enough to penetrate the separator and short the cell causing immediate failure.

Additionally, current production methods for lithium metal involve high-temperature electrolysis of a mixture of molten lithium chloride and potassium chloride that is relatively energy intensive. Typically, commercial production of lithium involves forming the metal using lithium chloride as a feedstock in a high temperature reaction vessel. In one process, a ratio of 55% LiCl is mixed with 45% KCl to produce a molten eutectic electrolyte. That material is fused and electrolyzed at about 450° C. This releases the chlorine as a gas, leaving molten lithium, which slags out or rises to the surface of the electrolyte. This requires collecting the lithium in this environment, particularly in a manner to prevent oxidation of the lithium, such as by wrapping in paraffin or the like. The resultant lithium material may be presented as bulk material, such as an ingot, or as a foil to be used with a substrate material. However, for the foil usage, it is necessary to laminate or adhere the lithium foil to the substrate as a separate process.

In addition, lithium metal films are desirable as “thin” films. As used herein, “thin films” are those 20 μm or smaller. Current methods produce thin films by extrusion rolling processes. However, such processes are expensive and produce films without desired properties (e.g., being thicker than desired or undesired remains of lubricant or having an undesirably high surface roughness). Thus, there remains a need for a lower cost, lower energy consumption process for forming lithium thin films.

### SUMMARY

Certain embodiments described herein relate generally to a method of producing lithium. The method comprises forming an electrolyte solution comprising a lithium salt, a solvent, and an additive selected from the group consisting of lithium nitrate (“LiNO₃”), adiponitrile, fluoroethylene carbonate, vinylene carbonate, vinylethylene carbonate, phenylethylene carbonate, trifluoromethyl propylene carbonate, allyl methyl carbonate, chloroethylene carbonate, succinic anhydride, maleic anhydride, phthalic anhydride, methyl benzoate, bromobutyrolactone, methyl chloroformate, vinyl acetate, ethylene sulfite, propane sultone, propene sultone, butane sultone, propylene sulfite, butylene sulfite, dimethyl sulfite, diethyl sulfite, glycolide, dimethyl glycolide, tetramethyl glycolide, N-acetyl caprolactam, succinimide, 2-vinylpyridine, 2-cyanofuran, methyl cinnamate, and vinyl ethylene sulfite. The lithium is electroplated on a substrate. A protective layer is formed on the electroplated lithium.

Another embodiment relates to a method of forming lithium metal thin films having protective surface layer. The method comprises forming an electrolyte solution comprising a lithium salt, a solvent, and an additive selected from the group consisting of LiNO₃, adiponitrile, fluoroethylene carbonate, vinylene carbonate, vinylethylene carbonate, phenylethylene carbonate, trifluoromethyl propylene carbonate, allyl methyl carbonate, chloroethylene carbonate, succinic anhydride, maleic anhydride, phthalic anhydride, methyl benzoate, bromobutyrolactone, methyl chloroformate, vinyl acetate, ethylene sulfite, propane sultone, propene sultone, butane sultone, propylene sulfite, butylene sulfite, dimethyl sulfite, diethyl sulfite, glycolide, dimethyl glycolide, tetramethyl glycolide, N-acetyl caprolactam, succinimide, 2-vinylpyridine, 2-cyanofuran, methyl cinnamate, and vinyl ethylene sulfite. A copper foil is rolled from a copper foil roller through the electrolyte solution to a lithium coated copper foil roller. Lithium cations are reduced at a cathode (i.e., copper foil) and depositing lithium metal, such as lithium metal thin film, on the copper foil as it passes through an electroplating region within the electrolyte solution at a temperature of 15-80° C., forming lithium coated copper foil. A protective layer is formed on the lithium metal thin film. The lithium metal coated copper foil is rolled about the lithium metal coated copper foil roller.

Another embodiment relates to a lithium deposition system. The system includes a copper foil roll disposed on an initial roller and have a copper foil extending through a plating bath to a final roller. At least one anode is positioned in electrical communication with the plating bath. A cathode is in electrical communication with the electroplating bath and a power source in communication with the at least one anode and the cathode. The system includes a catholyte comprising a lithium salt, a solvent, and an additive selected from the group consisting of LiNO₃, adiponitrile, fluoroethylene carbonate, vinylene carbonate, vinylethylene carbonate, phenylethylene carbonate, trifluoromethyl propylene carbonate, allyl methyl carbonate, chloroethylene carbonate, succinic anhydride, maleic anhydride, phthalic anhydride, methyl benzoate, bromobutyrolactone, methyl chloroformate, vinyl acetate, ethylene sulfite, propane sultone, propene sultone, butane sultone, propylene sulfite, butylene sulfite, dimethyl sulfite, diethyl sulfite, glycolide, dimethyl glycolide, tetramethyl glycolide, N-acetyl caprolactam, succinimide, 2-vinylpyridine, 2-cyanofuran, methyl cinnamate, and vinyl ethylene sulfite. The at least one anode positioned adjacent to the copper foil as the cathode in an electroplating region of the plating bath.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1A shows a one-compartment cell, and FIG. 1B shows a two-compartment cell.

FIGS. 2A-2C show electrodeposited Li-metal thin films having a surface-protective layer. FIG. 2A shows low-magnified and FIG. 2B shows high-magnified scanning electron microscope (“SEM”) images of electrodeposited Li-metal thin film. FIG. 2C shows a side-view of 5 min. deposited Li-metal films having 20 μm.

FIGS. 3A-3B show the results of Li-metal deposited by 1 M lithium bis(fluorosulfonyl)imide (“LiFSI”) in dimethoxyethane with deposition current density (“J_{dep}”) of 2 mA/cm². FIGS. 3C-3D show the results of Li-metal deposited without a protective layer by 1 M of LiFSI and 0.3 M LiNO₃ in dimethoxyethane with J_{dep} of 10 mA/cm². FIGS. 3E-3F show an embodiment of the present invention where a protective layer is co-deposited with 1 M of LiFSI, 0.3 M of LiNO₃, and 0.2 M of vinylene carbonate in dimethoxyethane with J_{dep} of 100 mA/cm².

FIG. 4 is a graph of battery cycling data, wherein line (A) is commercial lithium metal; line (B) is electrodeposited lithium metal from 1 M LiFSI and 0.3 M LiNO₃ in dimethoxyethane (FIGS. 3C-3D); and line (C) is electrodeposited lithium metal from 1 M LiFSI, 0.3 M LiNO₃, and 0.2 M vinylene carbonate in dimethoxyethane (FIGS. 3E-3F). All lithium metal films have the same thickness (20 μm). Cathode is lithium cobalt oxide having same capacity. A battery electrolyte for all is 1.2M LiPF₆ in a 3:7 ratio of ethylene carbonate (“EC”) to ethyl methyl carbonate (“EMC”).

FIG. 5 shows one embodiment of a method for electrodeposition of lithium metal.

FIG. 6A shows a method of lithium manufacturing utilizing a roll-to-roll scalable process based on a one-compartment system. FIG. 6B shows a method of lithium manufacturing utilizing a roll-to-roll scalable process based on a two-compartment system.

FIG. 7 shows a table summarizing surface composition of an electrodeposited lithium metal thin film having a surface-protective layer of the present invention analyzed by X-ray photoelectron spectroscopy (“XPS”).

FIG. 8 is a graph illustrating XPS depth profiles of an electrodeposited lithium metal thin film having a surface-protective layer of the present invention.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Embodiments described herein relate generally the use of a room temperature electrodeposition method and the optimization of process parameters and conditions to produce a surface-protected lithium metal onto a conductive substrate from an aqueous source of Li-ions through a lithium-ion conducting separator. As used herein “room temperature” shall mean temperatures within 15-80° C.

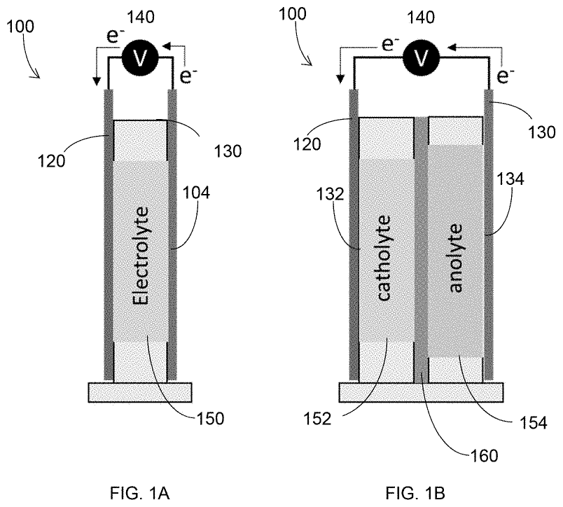

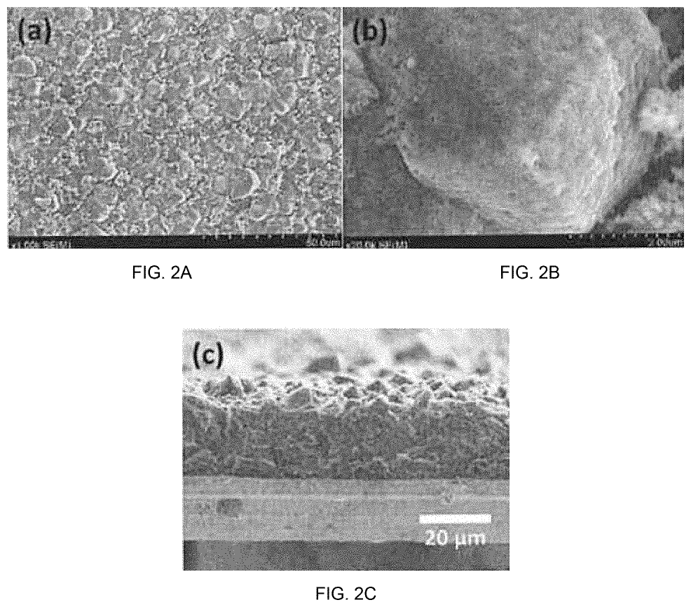

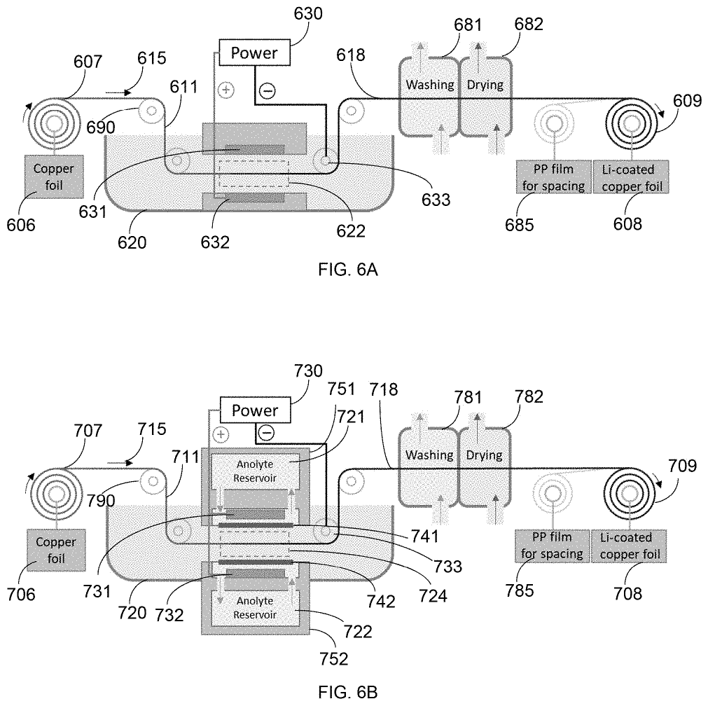

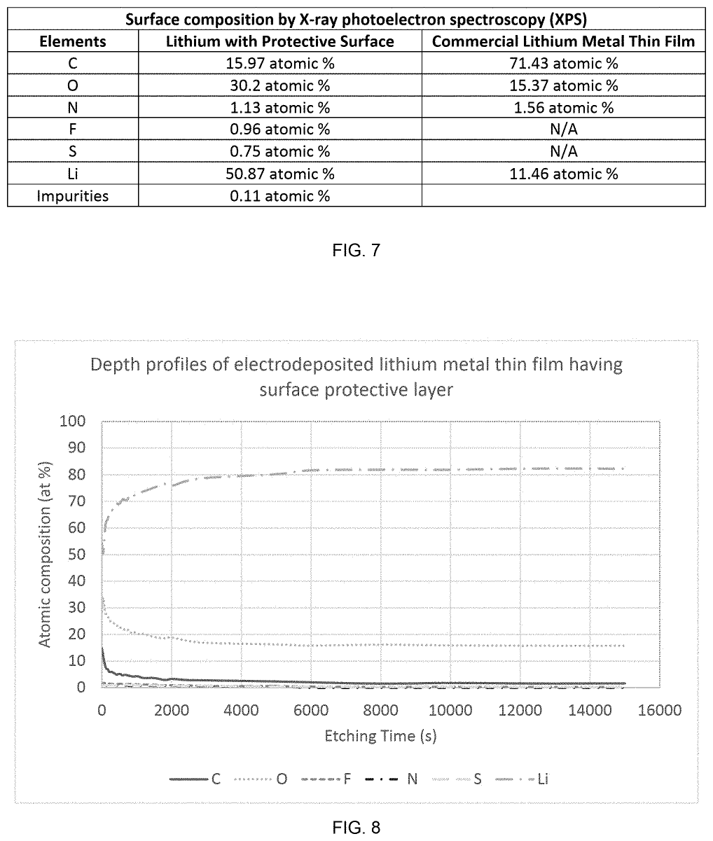

In one embodiment, an electrolytic cell is utilized for the production of lithium. A one-compartment cell structure (FIG. 1A) or a two-compartment cell structure (FIG. 1B) may be used. A scalable roll-to-roll process is illustrated in FIG. 6A or FIG. 6B.

FIG. 1A illustrates one embodiment of a lithium production system having the electrolytic cell 100 comprising a single compartment (i.e., a one-compartment cell 104). The illustrated embodiment of a one-compartment cell 104 is composed of organic electrolyte 150, a cathode, such as a copper working electrode 120, and an anode, such as a lithium (or platinum) counter electrode 130. The lithium metal is deposited onto the copper working electrode 120 by applying cathodic current (potential) from a power source 140. Primary lithium source is from an electrolyte 150 containing lithium salts. When lithium metal is used as the counter electrode 130, lithium continuously comes out so the lithium concentration in electrolyte is being kept same. In this case, lithium at the counter electrode 130 is continuously consumed so that lithium should be replaced. When platinum metal is used as the counter electrode 130, the concentration of lithium in the electrolyte 150 decreases as deposition occurs. In order to keep the same concentration, lithium salts should be continuously supplied. In both cases, lithium metal at the counter electrode 130 or/and lithium salts in the electrolyte 150 are consumed.

FIG. 1B illustrates a lithium production system 100 as a two-compartment cell system. A power source 140 is also provided, in this embodiment in communication with the two-compartments of the system. The two-compartment cell system includes a first compartment, which may be an anodic compartment 134 of the two-compartment cell with an anolyte 154 and a cathodic compartment 132 of the two-compartment cell with a catholyte 152. The anolyte 154 provides a renewable source of lithium. These two electrolytes are separated by a Li-ion conducting membrane 160. A copper working electrode 120 and platinum counter electrode 130 are used. Lithium metal is electrodeposited onto copper working electrode 120 at catholyte 152 side by applying cathodic current (potential). The primary lithium source is the Li-containing catholyte 152. As deposition occurs, lithium ions come from the anolyte 154 side to keep the same concentration of lithium. The anolyte 154 is preferred to be a highly concentrated lithium salt, such as lithium carbonate or lithium chloride, which are among the cheapest lithium salts.

The Li-ion conducting membrane 160 further maintains physical separation of the anolyte 154 and the catholyte 152. The membrane 160 is a nonporous hybrid membrane that allows for asymmetric media (e.g., aqueous on one side, organic on the other side) while limiting transport to Li-ions by facilitated diffusion through the membrane. For example, in one embodiment the membrane 160 may be inorganic, such as commercially available ceramic membranes. Further, the membrane 160 may be an organic polymer or a hybrid organic polymer-inorganic composite. In one embodiment, the membrane 160 has the following properties: (1) does not allow the movement of water from the anolyte 154 to the catholyte 152, since the lithium metal being deposited on the cathode 120 will react with water; (2) is ion-conducting, but not necessarily limited to Li-ions, as it is easier to pre-treat the Li-ion feedstock and control its impurities; (3) is stable against both aqueous and organic media; and (4) has sufficient dielectric stability so as not to have its structure compromised during electrodeposition runs (voltages can approach 10 V). Commercial membranes, such as the lithium-ion conducting glass by Ohara Corporation or lithium-ion conducting polymeric membrane by Ionic Materials, Inc., can be used, as well as any other composite membranes with lithium-ion conductors embedded in a non-porous matrix.

In some embodiments, the working electrode 120 is a copper electrode. The working electrode 120 may comprise copper foil. Alternatively, the electrode 120 may be one or more of copper, iron, nickel, conductive metal, and conductive metal foams or mesh.

Primary lithium salts that may serve as the electrolyte includes primary lithium salts in organic electrolyte are one or more from the list: lithium bis(fluorosulfonyl)imide (“LiFSI”), lithium bis(trifluoromethanesulfonyl)imide (“LiTFSI”), lithium bis(pentafluoroethanesulfonyl)imide (“LiBETI”), lithium hexafluorophosphate (“LiPF₆”), lithium hexafluoroarsenate (“LiAsF₆”), lithium perchlorate (“LiClO₄”), lithium tetrafluoroborate (“LiBF₄”), lithium bis(oxalate)borate (“LiBOB”), lithium difluoro(oxalate)borate (“LiDFOB”), lithium bis(fluoromalonato)borate (“LiBFMB”), lithium tetracyanoborate (“LiTCB”), lithium dicyanotriazolate (“LiDCTA”), lithium dicyano-trifluoromethyl-imidazole (“LiTDI”), and lithium dicyano-pentafluoroethyl-imidazole (“LiPDI”).

In one embodiment, the material includes a protective coating on the lithium. While protective coating layers can be obtained through a number of subsequent processing steps, these require post-deposition or not in-situ processes. The higher current densities during electrodeposition and thus shorter deposition times described here are a first-of-its kind result that enables a reduced fabrication time. For example, in one embodiment the additives process described herein took an on the order of minutes rather than the 1+ hours.

The purpose of the additives is twofold: (1) to produce a protective coating layer on the lithium metal, in-situ and during the formation of the lithium metal (i.e., a one- or single-step solution to getting high purity lithium and a protective coating at the same time without any subsequent processing) and (2) to enable higher deposition current densities (J_{dep}), and hence shorter deposition times, during the electrodeposition process; a significant difference between this invention and others because it helps process, design, and productivity.

The protective layer is formed through the use of additives in the electrodeposition process selected from the group consisting of LiNO₃, adiponitrile, fluoroethylene carbonate, vinylene carbonate, vinylethylene carbonate, phenylethylene carbonate, trifluoromethyl propylene carbonate, allyl methyl carbonate, chloroethylene carbonate, succinic anhydride, maleic anhydride, phthalic anhydride, methyl benzoate, bromobutyrolactone, methyl chloroformate, vinyl acetate, ethylene sulfite, propane sultone, propene sultone, butane sultone, propylene sulfite, butylene sulfite, dimethyl sulfite, diethyl sulfite, glycolide, dimethyl glycolide, tetramethyl glycolide, N-acetyl caprolactam, succinimide, 2-vinylpyridine, 2-cyanofuran, methyl cinnamate, and vinyl ethylene sulfite. Specifically, the additives are included in the electrolyte and added at known concentrations, typically occur on the order of 0.1-1 M. Mixed compositions may be used. During the electrodeposition process, the additives electrochemically break down and form a polymeric (carbon-based) protective layer on the top of electrodeposited lithium metal. Additional additives allow one to tune the exact atomic composition of the protective layer similarly. For example, if fluoroethylene carbonate is included, elements of fluorine can be incorporated in the layer in turn affecting final lithium performance in a battery. In this way, the selection of additives enables one of skilled in the art to select materials to be incorporated into the protective layer.

As shown in FIG. 1B, the cathode 120 is associated with a catholyte 152. The catholyte 152 serves as the electrolyte for the cathode 120. In one embodiment, the catholyte 152 includes a lithium salt in an organic solvent. For example, the lithium salt may be selected from LiFSI, LiTFSI, LiBETI, LiPF₆, LiAsF₆, LiClO₄, LiBF₄, LiBOB, LiDFOB, LiBFMB, LiTCB, LiDCTA, LiTDI, and LiPDI or combinations thereof. The organic solvent may be selected from ether-based solvents. In one embodiment, more than one salt and/or more than one solvent may be used to form the catholyte 152.

As also shown in FIG. 1B, the anode 130 is associated with an anolyte 154. The anolyte 154 serves as the electrolyte for the anode 130. In one embodiment, the anolyte 154 includes a lithium salt in a water solvent. For example, the lithium salt may be selected from Li₂CO₃, LiHCO₃, Li₂SO₄, LiHSO₄, or combinations thereof. In one embodiment, more than one salt and/or more than one solvent may be used to form the anolyte 154. In general, the pH of the anolyte solution may be adjusted to be as neutral as possible (i.e., pH 7) with the use of lithium bases such as Li₂CO₃ in order to minimize hydrogen ion concentration and reduce the possibility of co-reduction on the cathode 120 as hydrogen gas.

The electrolyte 150 and the catholyte 152 may utilize an organic solvent. For example, an organic electrolyte solvent may be elected from ether solvents, such as from the group consisting of: amyl ethyl ether, cyclopentyl methyl ether, diethyl ether, DME, dimethoxymethane (“DMM”), diisopropyl ether, dibutyl ether, di(propylene glycol) ether, 1,4-dioxane, ethyl butyl ether, methoxyethane, methyl butyl ether, 2-methyltetrahydrofuran, polyethylene glycol (“PEG”), propylene glycol methyl ether, tetrahydrofuran (“THF”), thtrahydrofufuryl alcohol, tetrahydropyran, 2,2,5,5,-tetramethyltetrahydrofuran, dimethyl sulfoxide (“DMSO”), and N,N-dimethylformamide (“DMF”).

For embodiments with a two-compartment cell structure, as shown in FIG. 1B, a secondary lithium source may be provided in the anolyte 154 chosen from lithium carbonate, lithium sulfate, or lithium halides. The catholyte 152 and the anolyte 154 may be different or the same. The purpose of a two-compartment cell is providing Li⁺ from cheap anolyte 154 to expensive catholyte 152. Water-based lithium carbonate/sulfate/halide in anolyte 154 is the cheapest lithium source, and the catholyte 152 is composed of Li-containing expensive organic media with multiple additives.

A deposition current (J_{dep}) is applied to the cell. In one embodiment, the deposition current density for is in a range of 0.1-100 mA/cm².

It should be appreciated that the system 100 may be provided with an electrolyte supply/recirculation subsystem. Further, the two-compartment system, as shown in FIG. 1B, may include an anolyte supply subsystem in communication with the anodic compartment 134 of the two-compartment cell to provide an anolyte and a catholyte supply subsystem in communication with the cathodic compartment 132 of the two-compartment cell. Thus, one or both of the electrolytes may be replenished.

Another embodiment of the present disclosure relates to a method of producing lithium. For example, one method of production utilizes a system, such as system 100 shown in FIGS. 1A-1B.

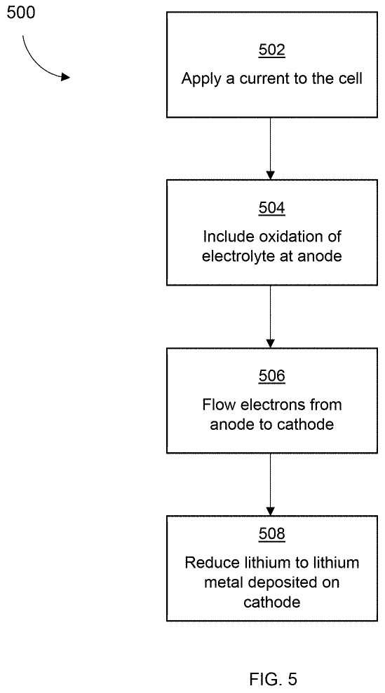

FIG. 5 illustrates the steps of a method 500 for the production of lithium. At 502, a current is applied to the electrolytic cell at the anode. At 504, in the one-compartment cell embodiment, the electrolyte is oxidized at the anode releasing electrons that flow to the cathode resulting in reduction of lithium from the electrolyte and electrodeposition of lithium metal onto the working electrode. In the two-compartment cell embodiment, also at 504, the anolyte is oxidized at the anode, releasing electrons that flow to the cathode. At 506, balancing flow of ions from the catholyte flows through the membrane. At 508, the cathode, the lithium cations are reduced and deposited as lithium metal on the cathode. For example, Li-ions flow through the membrane to maintain the charge balance as Li-ions are reduced to neutral lithium metal. The electrodeposition process requires an applied current or applied potential.

In one embodiment, the method 500 of production includes one or more process parameters. The use of additives allows for higher current densities and leads to shorter and significantly, more favorable deposition times, thus expanding the range of electrodeposition process parameters than were obtainable previously in prior work. In overall production, the protective layer is formed in-situ during electrodeposition, which circumvents any subsequent processing steps; the lithium metal formed previously using prior would be subject to post-processing steps. Further, the additive process enables the direct formation of a lithium material with a protective coating in a roll-to-roll manufacturing scheme, such as shown in FIGS. 6A-6B. The process parameters may be controlled to provide a desired result. In one embodiment, the process parameters include cathode materials, anode materials, current density, duration of electrodeposition time, electrolyte composition, and substrate properties (e.g., material, surface texture, and pre-treatment). The described system operates in an atmosphere. In one embodiment, the cell can be operated outside of a controlled a glovebox and in ambient, as long as the electrodeposited lithium metal film is protected from air (particularly from oxygen, nitrogen, moisture and carbon dioxide) with a thin coat of non-evaporating organic solvent (e.g., by immediately dipping in propylene carbonate after electrodeposition). Lithium metal reacts with the components of air as follows:

2Li+½O₂→Li₂O (1a)

Li₂O+H₂O→2LiOH (1b)

2LiOH+CO₂→Li₂CO₃+H₂O (1c)

3Li+½N₂→Li₃N (2)

One process parameter that can be varied is lithium feedstock flow rate. There is expected to be an optimum lithium feedstock flow rate, as the concentration of Li-ions in the catholyte needs to be maintained as the Li-ions are depleted from solution during deposition onto the cathode substrate. In addition, the anolyte circulation is crucial so as to minimize oxygen gas bubble accumulation on the anode. Bubble accumulation on the anode limits the anode surface area exposed to the anolyte, and can thus affect the rate of electrodeposition. Those skilled in the art will appreciate that the flow rate will depend on the size and dimensions of the flow cell, which values can be predicted. For certain glass flow cell embodiments, flow rates of 1-100 mL/min, and more specifically 5-80 mL/min work well for the electrodeposition process.

Another process parameter that can be varied is the salt used as electrolyte. It has been found that various lithium salts (e.g., LiFSI, LiTFSI, LiBETI, LiPF₆, LiAsF₆, LiClO₄, LiBF₄, LiBOB, LiDFOB, LiBFMB, LiTCB, LiDCTA, LiTDI, LiPDI, and mixtures thereof) can be dissolved in ether-based organic solvents (e.g., amyl ethyl ether, cyclopentyl methyl ether, diethyl ether, DME, DMM, diisopropyl ether, dibutyl ether, di(propylene glycol) ether, 1,4-dioxane, ethyl butyl ether, methoxyethane, methyl butyl ether, 2-methyltetrahydrofuran, PEG, propylene glycol methyl ether, THF, tetrahydrofufuryl alcohol, tetrahydropyran, 2,2,5,5,-tetramethyltetrahydrofuran, DMSO, and DMF, and mixtures thereof) to provide a catholyte that is at least 0.1 molar concentration in Li-ions.

With regard to the current density, the current density (at a fixed electrodeposition time duration) primarily affects the thickness of the lithium metal thin film such that higher current densities result in thicker lithium metal thin film when the deposition time is same. In one embodiment, the current density is from 0.1-100 mA/cm².

With regard to the duration of electrodeposition time, increased time (at fixed current density) results in increased overall lithium metal film thickness. An important feature of lithium manufacturing is to achieve a desired thickness in the shortest amount of time (efficiency and productivity). Typically, the most cited range for potential battery applications is 20 μm of lithium. The presently described methods enable this thickness to be achieved in the order of minutes using this invention rather than hours. In other cases some thicker lithium metal may be needed (e.g. 100 μm) which in turn can be achieved on the order of tens of minutes. These considerations with respect to time and thickness also play an important role in scalable production, most notably roll-to-roll manufacturing.

In roll-to-roll based on one-compartment configuration, an initial roller 606 is engaged with a copper foil roll 607 having a rolled length of copper foil 611 serves a substrate feedstock to be immersed in the electrolyte solution bath 620. For one-compartment cells, the electrolyte solution includes a single cell with organic electrolyte and the additive. The copper foil 611 proceeds along a roll pathway 615 from the roll of copper foil 607 to a final roller 608. The copper roll 606 feeds the copper foil 611 through an electrolyte in a plating bath 620. The electrolyte bath 620 has electricity applied to it by a power source 630. For example, in FIG. 6A, one-compartment roll-to-roll system for two-sided deposition is shown in with a first anode 631 and a second anode 632. The copper foil 611 works as a cathode by an electrical contact with one of mechanical role-to-roll components 633. The copper foil 611 passes through the electrolyte bath 620 to deposit the lithium on to it. The electroplating of the lithium on the copper foil 611 may occur in the electroplating region 622 of the electrolyte bath 620. The Li-coated copper foil 618 proceeds to be wound about a Li-coated copper foil roller 608 forming wound Li-coated copper foil 609. The Li-coated copper foil 618 may pass through a washing station 681 and/or a drying station 682. Further a spacing material, such as a non-conductive polymer film 685, may be co-rolled with the Li-coated copper foil 618, such that the wound Li-coated copper foil 609 includes the spacer between successive layers of the Li-coated copper foil 618. Mechanical roll-to-roll components 690, such as routing or movement rollers maybe utilized. The presence of the additive in the electrolyte bath 620 results in the formation of a protective coating directly on the Li-coated copper foil 618 during the electroplating. In the same set-up, the one-sided deposition is also possible when one of anodes 631 and 632 is not utilized, either selectively not receiving power or in a design physically including only one of the first anode 631 and the second anode 632.

An alternative embodiment is shown in FIG. 6B as a two-compartment roll-to-roll system. In roll-to-roll based on two-compartment configuration, an initial roller 706 is engaged with a copper foil roll 707 having a rolled length of copper foil 711 serves a substrate feedstock to be immersed in the catholyte solution bath 720. For two-compartment cells, the catholyte solution in the plating bath 720 includes organic electrolyte and the additive. A first container 751 may contain a first anode 731 and an associated first anolyte reservoir 721. The first container 751 is in communication with the plating bath 720 via a first Li-conducting membrane 741. A second container 752 may contain a second anode 732 and an associated second anolyte reservoir 722. The second container 752 is in communication with the plating bath 720 via a second Li-conducting membrane 742. The first container 751 and the second container 752 are positioned opposite each other with the electroplating region 724 defined in the plating path there between. For example, the anolyte reservoir 721 and the first anode 731 associated therewith may be within the first container 751 and the second anolyte reservoir 722 and the second anode 732 associated therewith may be within the second container 752. The copper foil 711 proceeds along a roll pathway 715 from the roll of copper foil 707 to a final roller 708. For two-compartment cells, the copper roll 707 feeds the copper foil 711 through a catholyte bath 720 (electrolyte in a plating bath). The anolyte solutions 721 and 722 includes aqueous lithium salts. The anolyte solutions are circulated from their reservoir 721 and 722. The electrolyte bath 720 has electricity applied to it by a power source 730. For example, in FIG. 6B, a two-component roll-to-roll system for two-sided deposition is shown in two anodes 731 and 732 and the copper foil 711 as a cathode by an electrical contact with one of mechanical role-to-roll components 733. The copper foil 711 passes through the catholyte bath 720 to deposit the lithium on to it. The electroplating of the lithium on the copper foil 711 may occur in the electroplating region 724 of the catholyte bath 720. The Li-coated copper foil 718 proceeds to be wound about a Li-coated copper foil roller 708 forming a wound Li-coated copper foil roll 709. The Li-coated copper foil 718 may pass through a washing station 781 and/or a drying station 782. Further a spacing material, such as a non-conductive polymer film 785, may be co-rolled with the Li-coated copper foil 718. Mechanical roll-to-roll components, such as routing or movement rollers 790 may be utilized. The presence of the additive in the catholyte bath 720 results in the formation of a protective coating directly on the Li-coated copper foil 718 during the electroplating. In the same set-up, the one-sided deposition is also possible when one of anolytes 721 and 722 and one of anodes 731 and 732 are not utilized.

For prior art systems with a deposition time that is on the order of hours to obtain 20 μm of lithium, one needed a very long roll of copper foil and/or run at exceedingly small speeds. In this way, the use of additives and shorter deposition times (down to 5 minutes) helps answer the need to have thin films with some specified pre-determined thickness in a much more efficient and streamlined approach than was achievable beforehand.

In another embodiment, the cathode includes a substrate that is to serve as a substrate under the lithium. In terms of producing lithium metal laminates, the materials produced in accordance with the processes described herein yield significantly better materials compared to lithium pressed and rolled onto a current collector. The latter can suffer from delamination, causing areas of non-uniform electrical contact with the current collector. In a particular embodiment, the cathode may comprise a substrate such as metal (e.g., Cu, Li), as well as composites such as carbon-coated metals (e.g., graphite on Cu) or oxide-coated substrates (e.g., Li₂S or LiAlO₂ on Cu) in the form of sheets, foils, and foams. The cathode may be the same material as the “substrate” underneath the lithium foil. Alternatively, the cathode and the substrate may be different, such as for use of the substrate as a sacrificial layer. The use of a different material may also be utilized due to their further alteration of the electrical properties of the lithium layer or due to particular morphological impacts on the deposited lithium.

The use of composite substrates (e.g., coatings such as graphite and oxides) can lead to enhanced stability of the lithium metal thin films as anodes, by providing an additional SEI that can suppress undesirable dendrite growth, formation of pockets of “dead” lithium (i.e., lithium metal that are electrically isolated from the current collector) and side-reactions with electrolyte that consume the active lithium metal. In particular, the ability to conformally coat all surfaces of a foam with lithium metal via electrodeposition can realize 3D-architectures for future battery configurations. Further, the substrate material may have a surface texture such as columnar or fibrous. These surface textures can increase the over-all surface area that can affect battery cycling behavior by decreasing the voltage drop across the electrodes.

### Examples

One-compartment cell. The electrolyte preparation consisted of 1 M of LiFSI, 0.3 M of LiNO₃, and 0.2 M of vinylene carbonate dissolved in dimethoxyethane. A copper foil and a lithium (or platinum) foil were used as working (lithium deposition side) and counter electrode, respectively. A deposition current of 100 mA/cm² was applied by a potentiostat.

Two-compartment cell. The catholyte preparation consisted of 1 M of LiFSI, 0.3 M of LiNO₃, and 0.2 M of vinylene carbonate dissolved in dimethoxyethane. Anolyte preparation consisted of: 4 M of Li₂CO₃ dissolved in concentrated H₂SO₄. The pH of the solution was adjusted to be 4 using NaOH pellets. A copper foil and a platinum foil were used as a working (lithium deposition side) and a counter electrode, respectively. A deposition current of 100 mA/cm² was applied by a potentiostat.

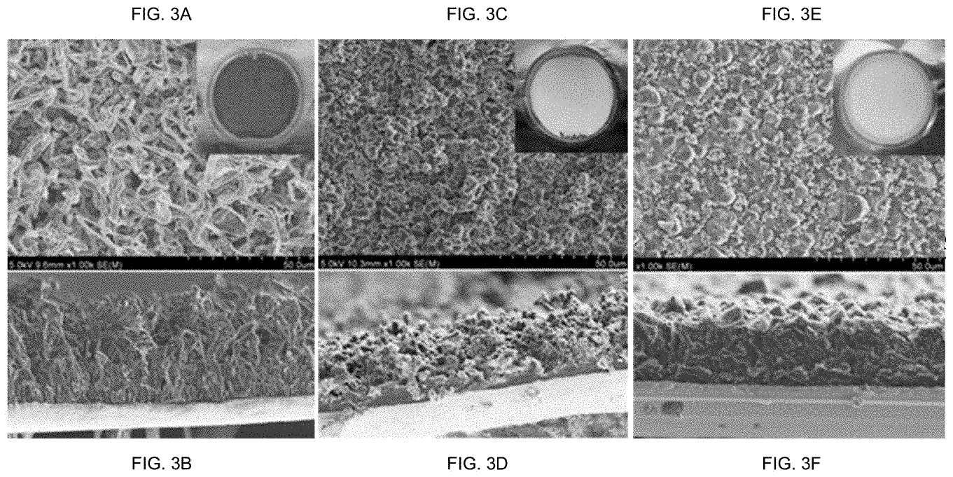

FIGS. 3A-3B show the results of electrodeposited Li-metal from the electrolyte consisted of 1 M LiFSI in dimethoxyethane with J_{dep} of 2 mA/cm².

FIGS. 3C-3D show the results of Li-metal deposited using 1 M LiFSI and 0.3 M LiNO₃ in dimethoxyethane with J_{dep} of 10 mA/cm². FIGS. 3E-3F show an embodiment of the present invention where a protective layer is included, and is co-deposited during the electrodeposition process through the inclusion of vinylene carbonate into the electrolyte mixture. Specifically, the electrolyte parameters used to make the coated lithium shown in FIGS. 3E-3F were 1 M of LiFSI and 0.3 M LiNO₃ and 0.2 M vinylene carbonate in dimethoxyethane with J_{dep} of 100 mA/cm².

It is also very important to note the difference in current density and that the protected lithium (FIGS. 3E-3F) is at an identical thickness as the unprotected lithium, but at 1/10 the time because of the difference in current densities used in the deposition. Namely, the electrolyte without any additives (LiNO₃ and vinylene carbonate) produce unusable dendrite Li-metal deposit, and dendrite is grown even using very slow deposition rate (low J_{dep}, 2 mA/cm²). The LiFSI and LiNO₃ mixture leading to unprotected lithium (as shown in FIGS. 3C-3D) used a deposition current of J_{dep} of 10 mA/cm², while another additive electrolyte mixture (shown in FIGS. 3D-3F) used J_{dep} of 100 mA/cm² (shorter deposition time, more productivity, higher quality, etc.).

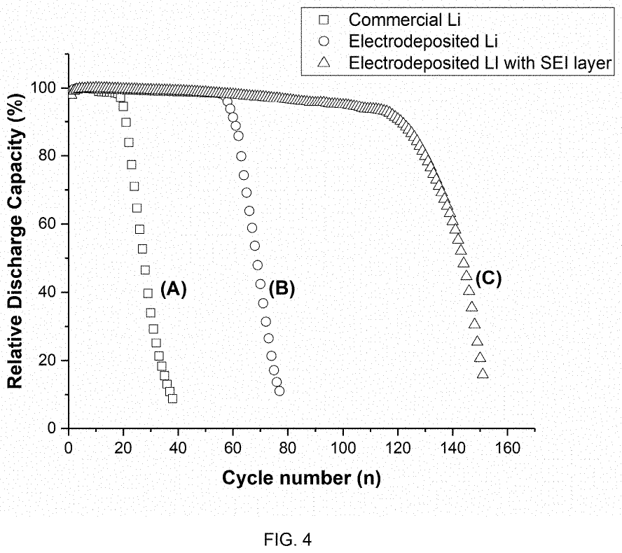

FIG. 4 is a graph of battery cycling data. Line (A) is commercial lithium metal; line (B) is electrodeposited lithium metal from 1 M LiFSI and 0.3M LiNO₃ in dimethoxyethane (FIGS. 3C-3D); and line (C) is electrodeposited lithium metal from 1 M LiFSI, 0.3 M LiNO₃, and 0.2 M vinylene carbonate in dimethoxyethane (FIGS. 3E-3F). All lithium metal thin films have the same thickness (20 μm). Cathode is lithium cobalt oxide having same capacity. A battery electrolyte for all is 1.2M LiPF₆ in a 3:7 ratio of EC:EMC. Li-metal deposited without additives (FIGS. 3A-3B) cannot be tested because its dendrite nature is not possible to be loaded in battery cells.

### Definitions

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method of producing lithium comprising:
forming an electrolyte solution comprising a lithium salt, a solvent, and an additive selected from the group consisting of lithium nitrate (“LiNO₃”), adiponitrile, fluoroethylene carbonate, vinylene carbonate, vinylethylene carbonate, phenylethylene carbonate, trifluoromethyl propylene carbonate, allyl methyl carbonate, chloroethylene carbonate, succinic anhydride, maleic anhydride, phthalic anhydride, methyl benzoate, bromobutyrolactone, methyl chloroformate, vinyl acetate, ethylene sulfite, propane sultone, propene sultone, butane sultone, propylene sulfite, butylene sulfite, dimethyl sulfite, diethyl sulfite, glycolide, dimethyl glycolide, tetramethyl glycolide, N-acetyl caprolactam, succinimide, 2-vinylpyridine, 2-cyanofuran, methyl cinnamate, and vinyl ethylene sulfite;
electroplating lithium on a substrate; and
forming a protective layer on the electroplated lithium.

2. The method of claim 1, wherein the additive has a concentration in the electrolyte solution of 0.1 to 1.0 M.

3. The method of claim 2, wherein the protective layer is a polymeric protective layer.

4. The method of claim 1, wherein the lithium salt is be selected from the group consisting of lithium bis(fluorosulfonyl)imide (“LiFSI”), lithium bis(trifluoromethanesulfonyl)imide (“LiTFSI”), lithium bis(pentafluoroethanesulfonyl)imide (“LiBETI”), lithium hexafluorophosphate (“LiPF₆”), lithium hexafluoroarsenate (“LiAsF₆”), lithium perchlorate (“LiClO₄”), lithium tetrafluoroborate (“LiBF₄”), lithium bis(oxalate)borate (“LiBOB”), lithium difluoro(oxalate)borate (“LiDFOB”), lithium bis(fluoromalonato)borate (“LiBFMB”), lithium tetracyanoborate (“LiTCB”), lithium dicyanotriazolate (“LiDCTA”), lithium dicyano-trifluoromethyl-imidazole (“LiTDI”), and lithium dicyano-pentafluoroethyl-imidazole (“LiPDI”) or combinations thereof, and the organic solvent may be selected from ether-based organic solvents or combinations thereof.

5. The method of claim 1, further comprising removing the deposited lithium metal.

6. The method of claim 1, wherein the cathode comprises a metallic foil and further comprising removing a lithium-coated metallic foil from the cell.

7. The method of claim 1, wherein reducing the lithium cations at the cathode and depositing lithium metal are at a temperature of 15-80° C.

8. A method of forming lithium metal thin films having protective surface layer comprising:
forming an electrolyte solution comprising a lithium salt, a solvent, and an additive selected from the group consisting of lithium nitrate (“LiNO₃”), adiponitrile, fluoroethylene carbonate, vinylene carbonate, vinylethylene carbonate, phenylethylene carbonate, trifluoromethyl propylene carbonate, allyl methyl carbonate, chloroethylene carbonate, succinic anhydride, maleic anhydride, phthalic anhydride, methyl benzoate, bromobutyrolactone, methyl chloroformate, vinyl acetate, ethylene sulfite, propane sultone, propene sultone, butane sultone, propylene sulfite, butylene sulfite, dimethyl sulfite, diethyl sulfite, glycolide, dimethyl glycolide, tetramethyl glycolide, N-acetyl caprolactam, succinimide, 2-vinylpyridine, 2-cyanofuran, methyl cinnamate, and vinyl ethylene sulfite, the electrolyte solution having an anode disposed therein;
rolling a copper foil from a copper foil roller through the electrolyte solution to a lithium coated copper foil roller;
reducing lithium cations at a copper foil (a cathode) and depositing lithium metal on the copper foil as it passes through an electroplating region within the electrolyte solution at a temperature of 15-80° C., forming lithium coated copper foil;
forming a protective layer on the lithium metal thin film; and
rolling the lithium metal coated copper foil about the lithium metal coated copper foil roller.

9. The method of claim 8, wherein a spacing film is co-rolled with the lithium metal coated copper foil about the lithium metal coated copper foil roller.

10. The method of claim 8, wherein prior to rolling about the lithium metal coated copper foil roller, the lithium metal coated copper foil passes through a washer and a dryer.

11. The method of claim 9, wherein the additive has a concentration in the electrolyte solution of 0.1 to 1.0 M.

12. The method of claim 8, wherein the lithium salt is be selected from the group consisting of lithium bis(fluorosulfonyl)imide (“LiFSI”), lithium bis(trifluoromethanesulfonyl)imide (“LiTFSI”), lithium bis(pentafluoroethanesulfonyl)imide (“LiBETI”), lithium hexafluorophosphate (“LiPF₆”), lithium hexafluoroarsenate (“LiAsF₆”), lithium perchlorate (“LiClO₄”), lithium tetrafluoroborate (“LiBF₄”), lithium bis(oxalate)borate (“LiBOB”), lithium difluoro(oxalate)borate (“LiDFOB”), lithium bis(fluoromalonato)borate (“LiBFMB”), lithium tetracyanoborate (“LiTCB”), lithium dicyanotriazolate (“LiDCTA”), lithium dicyano-trifluoromethyl-imidazole (“LiTDI”), and lithium dicyano-pentafluoroethyl-imidazole (“LiPDI”) or combinations thereof, and the organic solvent comprises an ether-based solvent

13. The method of claim 8, wherein electroplating region is positioned between a first container having the anode separated from the electrolyte solution by a first lithium ion permeable membrane and a second container having a second anode separated from the electrolyte solution by a second lithium ion permeable membrane.

14. A lithium deposition system comprising:
a copper foil roll disposed on an initial roller and have a copper foil extending through a plating bath to a final roller;
at least one anode positioned in electrical communication with the plating bath;
a cathode in electrical communication with the electroplating bath and a power source in communication with the at least one anode and the cathode;
a catholyte comprising a lithium salt, a solvent, and an additive selected from the group consisting of lithium nitrate (“LiNO₃”), adiponitrile, fluoroethylene carbonate, vinylene carbonate, vinylethylene carbonate, phenylethylene carbonate, trifluoromethyl propylene carbonate, allyl methyl carbonate, chloroethylene carbonate, succinic anhydride, maleic anhydride, phthalic anhydride, methyl benzoate, bromobutyrolactone, methyl chloroformate, vinyl acetate, ethylene sulfite, propane sultone, propene sultone, butane sultone, propylene sulfite, butylene sulfite, dimethyl sulfite, diethyl sulfite, glycolide, dimethyl glycolide, tetramethyl glycolide, N-acetyl caprolactam, succinimide, 2-vinylpyridine, 2-cyanofuran, methyl cinnamate, and vinyl ethylene sulfite, and
the at least one anode being adjacent to the copper foil in an electroplating region of the plating bath.

15. The system of claim 14, wherein the at least one anode comprises a first anode and a second anode positioned opposite each other with the electroplating region there between.

16. The system of claim 15, comprising a first container having the first anode and a second container having the second anode.

17. The system of claim 16, wherein the first container comprises a first anolyte reservoir and a first membrane separating the plating bath from the first anode.

18. The system of claim 17, wherein the second container comprises a second anolyte reservoir and a second membrane separating the plating bath from the second anode.

19. The system of claim 14, further comprising a polymer film in communication with the final roller and configured to co-roll with the copper foil.

20. The method of claim 14, wherein the lithium salt is be selected from the group consisting of lithium bis(fluorosulfonyl)imide (“LiFSI”), lithium bis(trifluoromethanesulfonyl)imide (“LiTFSI”), lithium bis(pentafluoroethanesulfonyl)imide (“LiBETI”), lithium hexafluorophosphate (“LiPF₆”), lithium hexafluoroarsenate (“LiAsF₆”), lithium perchlorate (“LiClO₄”), lithium tetrafluoroborate (“LiBF₄”), lithium bis(oxalate)borate (“LiBOB”), lithium difluoro(oxalate)borate (“LiDFOB”), lithium bis(fluoromalonato)borate (“LiBFMB”), lithium tetracyanoborate (“LiTCB”), lithium dicyanotriazolate (“LiDCTA”), lithium dicyano-trifluoromethyl-imidazole (“LiTDI”), and lithium dicyano-pentafluoroethyl-imidazole (“LiPDI”) or combinations thereof, and the organic solvent comprises an ether-based solvent.
